(19) United States
(12) Patent Application Publication
(10) Pub. No.: US 2026/0309257 A1
(43) Pub. Date: Oct. 8, 2026

(54) FLUID-CIRCULATION HOUSING AND METHOD FOR ASSEMBLING SUCH A HOUSING

(71) Applicant: VERNET, Ollainville (FR)

(72) Inventors: Nicolas Pottie, Le Perray En Yvelines (FR); Thierry Maraux, Les Clayes Sous Bois (FR)

(21) Appl. No.: 19/480,686

(22) PCT Filed: May 2, 2024
(86) PCT No.: PCT/EP2024/062135

§ 371 Date: Oct. 31, 2025

(30) Foreign Application Priority Data
May 4, 2023 (FR) 2304467

(51) Int. Cl. F16L 21/08; F16K 1/12; F16K 31/00; F16L 29/00

(52) U.S. Cl. CPC F16L 21/08; F16K 1/126; F16K 31/002; F16L 29/00

(57) ABSTRACT

The present invention relates to a multi-way fluid-circulation housing, comprising a body and a pipe assembled together. The body comprises a chamber, at least one opening leading into the chamber and, outside the chamber, a first lug through which a cylindrical opening passes. The pipe comprises a duct including a first end opening into the chamber and, outside the duct, a first lug through which a cylindrical opening passes. The housing further includes a first hollow cylindrical pin. In the assembled configuration of the housing, the cylindrical openings of the lugs of the body and of the pipe are aligned and the first pin passes through them to assemble the body and the pipe together, and the first pin receives a first attachment member for attaching the housing to a support member.

The present invention relates to a fluid-circulation housing with multiple channels, an assembly comprising such a housing fixed to a support and a method for assembling such a housing.

In many applications in the field of fluids, particularly for the circulation of fluids within an automobile, it is known to use circulation housings to direct a fluid into different channels based on certain control parameters, or to regulate the flow of this fluid.

It is known to use a fluid-circulation housing equipped with a regulating element, such as a thermostatic element, which enables directing an incoming fluid in the housing to one outlet channel or another, or to regulate the flow of this fluid. To enable the placement of the regulating element inside the housing, it is known to form the housing in two parts, namely a body and a pipe assembled together.

Generally, the body and the pipe of such a housing are assembled together using screws, a clip, by welding, or even by crimping. The housing is also fixed to a support, such as the casing of a vehicle, for example, using bolts. The presence of multiple fastening elements to assemble the housing, on the one hand, and to fix it to a support, on the other, increases the cost of the housing as well as its bulk, and makes its installation more complex.

JP-A-2002 078705, FR-A-2 759 174, and CN-A-113 236 815 describe examples of known circulation housings.

The aim of the invention is to propose a fluid-circulation housing that is simpler to assemble, more compact, and less expensive.

To this end, the invention relates to a fluid-circulation housing with multiple channels, including a body and a pipe assembled to each other, wherein:
the body comprises a chamber centered on a body axis, and at least one opening, leading into the chamber, forming one of the housing channels; and
the pipe comprises a duct, centered on a pipe axis, including a first end and a second end,

wherein, in an assembled configuration of the housing:
the pipe axis and the body axis are coincident;
the first end of the duct opens into the chamber;
the second end of the duct forms one of the channels of the housing.

According to the invention:
the body comprises a first lug, outside the chamber, traversed by a cylindrical opening oriented at an angle relative to the body axis;
the pipe comprises a first lug, outside the duct, traversed by a cylindrical opening oriented at an angle relative to the pipe axis;
the housing further includes a first hollow cylindrical pin; and
in the assembled configuration of the housing, the cylindrical opening of the first lug of the body and the cylindrical opening of the first lug of the pipe are aligned and are traversed by the first pin, to assemble the body and the pipe to each other, and the first pin is configured to receive a first fastening member, to fix the housing to a support.

By means of the invention, the lugs of the body and the pipe and the pins that pass through them enable simultaneously assembling the housing and fixing the housing to a support. The quantity of fastening elements necessary to assemble the housing and fix it to a support is thus reduced.

According to advantageous but non-mandatory aspects of the invention, the housing comprises one or more of the following features, taken individually or in any technically permissible combinations:
The cylindrical opening of the first lug of the body is oriented along an orthoradial axis to the body axis, and the cylindrical opening of the first lug of the pipe is oriented along an orthoradial axis to the pipe axis.
The body, outside the chamber, further comprises a second lug traversed by a cylindrical opening oriented at an angle relative to the body axis, or oriented along an orthoradial axis to the body axis; the pipe, outside the duct, further comprises a second lug traversed by a cylindrical opening oriented at an angle relative to the pipe axis, or oriented along an orthoradial axis to the pipe axis; and the housing further includes a second pin, which is a hollow cylindrical pin, configured to receive a second fastening member to fix the housing to the support. In the assembled configuration of the housing, the cylindrical opening of the second lug of the body and the cylindrical opening of the second lug of the pipe are aligned and are traversed by the second pin to assemble the body and the pipe to each other.
The body defines a body plane, parallel to the body axis and separating the body between a lower part and an upper part; and the pipe defines a pipe plane, parallel to the pipe axis and separating the pipe between a lower part and an upper part. In the assembled configuration of the housing: the body plane is coincident with the pipe plane, with the housing being separated by the body and pipe planes between a lower part, corresponding to the lower part of the body and the lower part of the pipe, and an upper part, corresponding to the upper part of the body and the upper part of the pipe; among the first lug of the body and the first lug of the pipe, one is located in the lower part of the housing and the other is located in the upper part of the housing; and among the second lug of the body and the second lug of the pipe, one is located in the lower part of the housing and the other is located in the upper part of the housing.
In the assembled configuration of the housing: among the first lug of the body and the second lug of the body, one is located in the lower part of the housing and the other is located in the upper part of the housing; and among the first lug of the pipe and the second lug of the pipe, one is located in the lower part of the housing and the other is located in the upper part of the housing.
In the assembled configuration of the housing: the first lug of the body and the second lug of the body are located in one of the lower part and upper part of the housing; and the first lug of the pipe and the second lug of the pipe are located in the other of the lower part and upper part of the housing.
The chamber is delimited at least in part by a cylindrical wall centered on the body axis; the pipe comprises a cylindrical outer face, extending, at the first end of the duct, along the pipe axis being centered on the pipe axis; the housing further includes a sealing gasket, mounted on the cylindrical outer face of the pipe; and, in the assembled configuration of the housing, the sealing gasket is compressed between the cylindrical outer face of the pipe and the cylindrical wall of the body.
The housing additionally comprises a regulating element, fixed at the first end of the duct to extend into the chamber in the assembled configuration of the housing, the regulating element being configured to regulate a flow of fluid in the chamber, the regulating element being preferably a thermostatic regulating element.

The invention also relates to an assembly comprising the housing described above, as well as the support and the first fastening member, wherein the housing is in an assembled configuration and the first fastening member passes through the first pin, being fixed to the support, to maintain the first lug of the body and the first lug of the pipe pressed against the support to fix the housing to the support.

The invention also relates to a method for assembling a multi-channel fluid-circulation housing as described above, comprising, in this order:
positioning the pipe in front of the body so that the pipe axis is coincident with the body axis and so that the first end of the duct is oriented in front of the chamber;
bringing the pipe towards the body to insert the first end of the duct into the chamber, until the cylindrical opening of the first lug of the pipe is aligned with the cylindrical opening of the first lug of the body; and
inserting the first pin into the cylindrical opening of the first lug of the body and into the cylindrical opening of the first lug of the pipe.

According to advantageous but non-mandatory aspects of the invention, the assembly method comprises one or more of the following features, taken individually or in any technically permissible combinations:
The positioning of the pipe in front of the body is implemented such that the cylindrical opening of the first lug of the pipe and the cylindrical opening of the first lug of the body extend along parallel axes, and the approach of the pipe towards the body is implemented by a translational movement along the pipe axis, without rotation around the pipe axis.
The positioning of the pipe in front of the body is implemented such that the cylindrical opening of the first lug of the pipe and the cylindrical opening of the first lug of the body extend along non-parallel axes, and the approach of the pipe towards the body is implemented by two successive movements:
   a translational movement of the pipe along the pipe axis, to insert the first end of the duct into the chamber, until the cylindrical opening of the first lug of the pipe and the cylindrical opening of the first lug of the body extend along intersecting axes, then
   a rotational movement of the pipe around the pipe axis, until the cylindrical opening of the first lug of the pipe is aligned with the cylindrical opening of the first lug of the body.

The invention will become clearer upon reading the following description, given solely by way of non-limiting example and made with reference to the drawings, wherein:

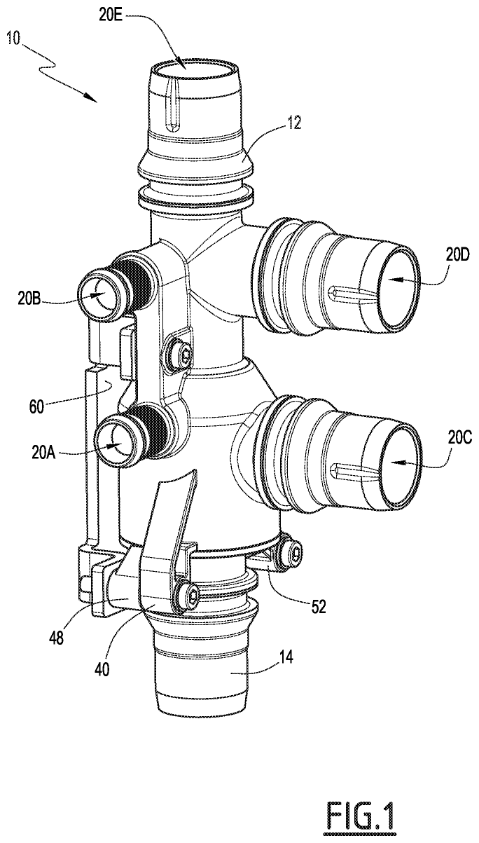

FIG. 1 is a perspective view of a fluid-circulation housing according to a first embodiment of the invention.

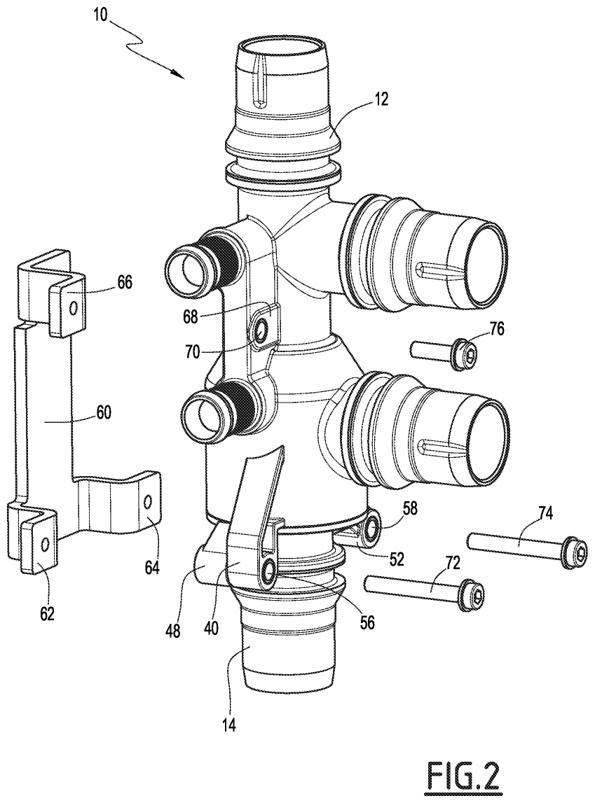

FIG. 2 is an exploded perspective view of the housing of FIG. 1.

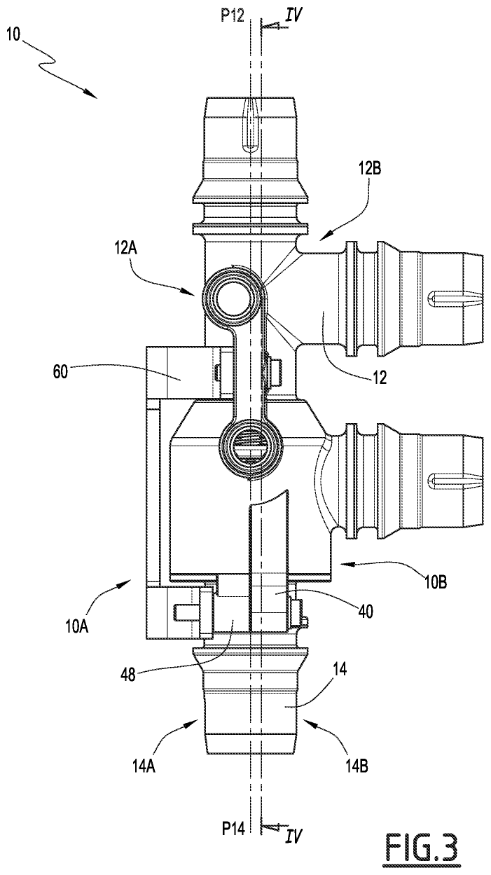

FIG. 3 is a side view of the housing of FIG. 1.

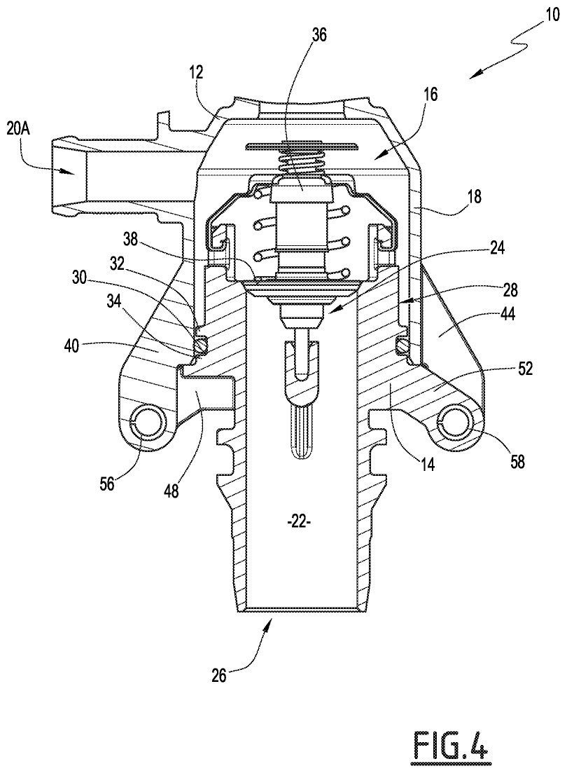

FIG. 4 is a sectional view of a part of the housing of FIGS. 1 and 3, according to plane IV of FIG. 3.

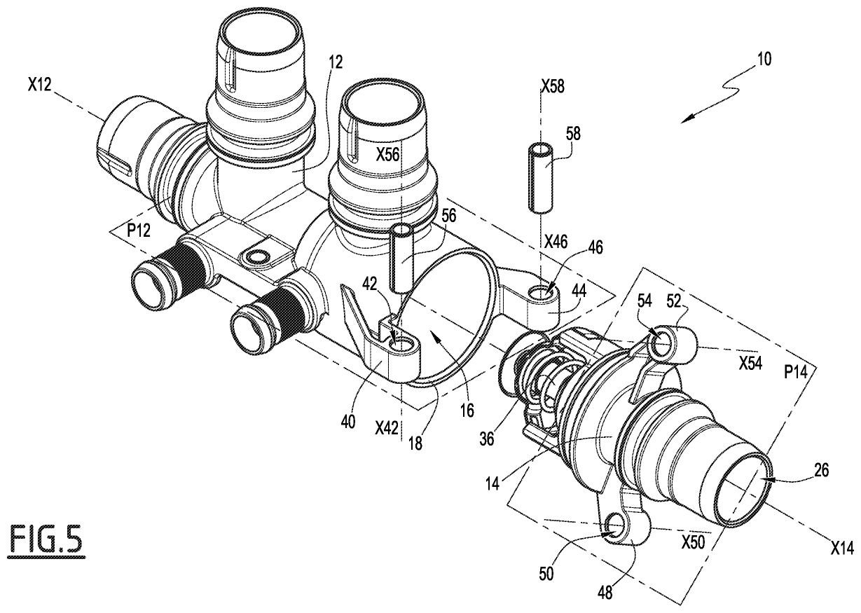

FIG. 5 is a perspective view of the housing of FIGS. 1 and 3, in a first assembly step.

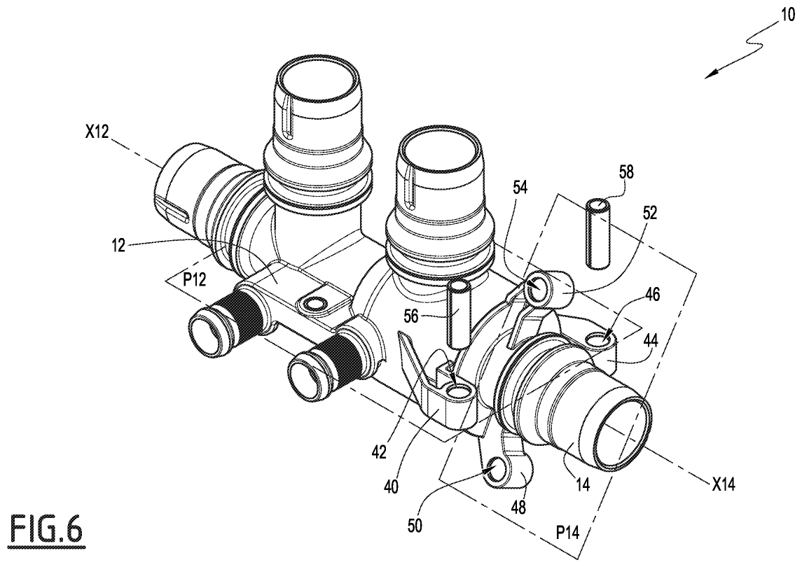

FIG. 6 is a perspective view of the housing of FIGS. 1 and 3, in a second assembly step.

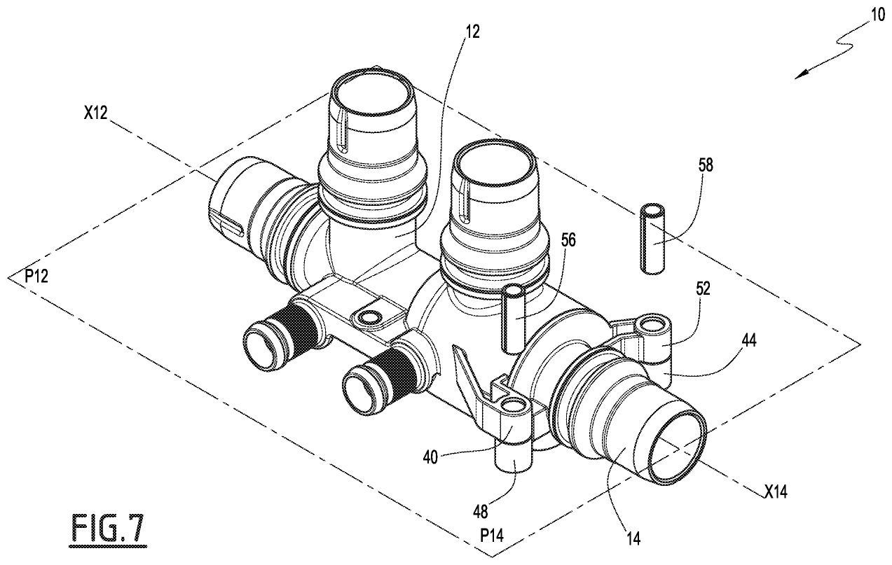

FIG. 7 is a perspective view of the housing of FIGS. 1 and 3, in a third assembly step.

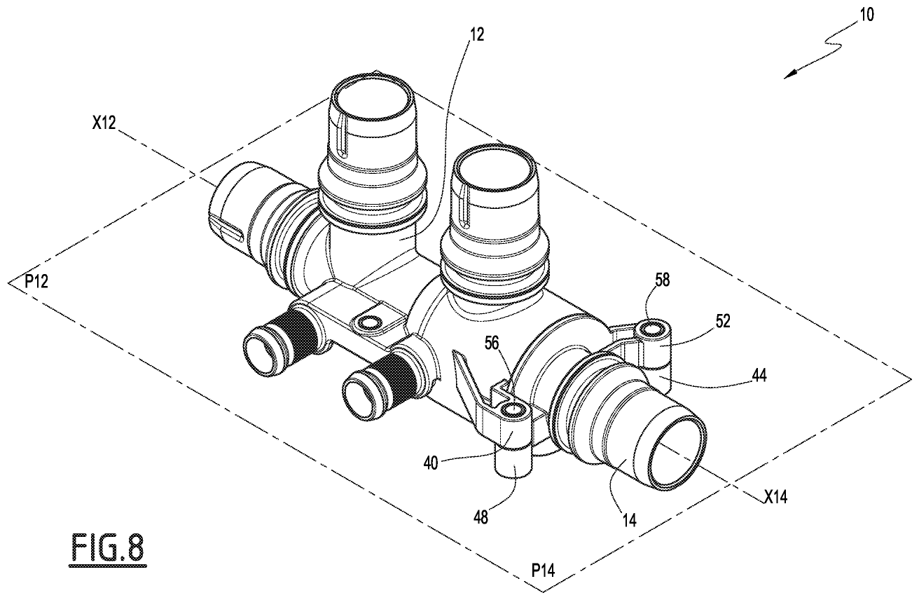

FIG. 8 is a perspective view of the housing of FIGS. 1 and 3, in a fourth assembly step.

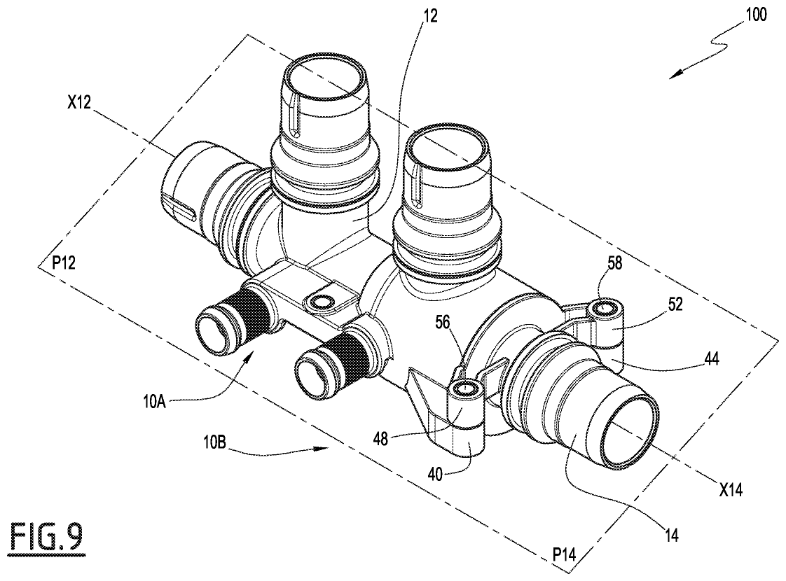

FIG. 9 is a perspective view of a fluid-circulation housing according to a second embodiment of the invention.

A fluid-circulation housing 10 according to a first embodiment of the invention is shown in FIGS. 1 to 8. This housing includes a body 12 and a pipe 14 that are assembled to each other.

In the example, the housing 10 is a six-channel housing. Each channel of the housing corresponds to an entry of a fluid into the housing, or to an exit of a fluid from the housing. Among the six channels, at least one entry channel and at least one exit channel are distinguished. The housing 10 is designed to direct and/or regulate a flow of fluid between the six channels. The detail of the operation of the six channels of the housing 10, known per se, is not described in more detail.

The housing 10 is intended to be integrated into a fluid installation, such as within an automobile, for example, particularly in a thermal engine cooling installation. Other applications of the housing 10 can be envisaged.

The body 12 includes an inner chamber 16, which is delimited in part by a cylindrical wall 18. More precisely, the cylindrical wall 18 has the shape of a right circular cylinder extending along a body axis X12, being centered on the body axis.

The body 12 comprises five through openings 20A, 20B, 20C, 20D, and 20E in its wall, which open into the chamber 16, thus forming each one of the channels of the housing 10.

The pipe 14 comprises an inner duct 22 of cylindrical shape, which extends along a pipe axis X14, being centered on the pipe axis. In the assembled configuration of the housing 10, the body and pipe axes X12 and X14 are coincident. The chamber 16 and the duct 22 are in continuation of each other, so that the duct 22 opens into one end of the chamber 16. More precisely, the duct 22 has a first end 22, which opens into the chamber 16, and a second end 26, which is located outside the body 12. The second end 26 of the duct 20 thus forms one of the channels of the housing 10. A circulation of fluid is thus possible between the chamber 16 and the duct 22.

The pipe 14 comprises a cylindrical outer face 28, which extends along a pipe axis X14, being centered on the pipe axis, at the first end 24 of the duct 22. In other words, the cylindrical outer face surrounds the first end of the duct. Thus, in the assembled configuration of the housing 10, the cylindrical outer face 28 of the pipe 14 is located inside the chamber 16, being surrounded by the cylindrical wall 18. More precisely, the cylindrical outer face 28 has the shape of a right circular cylinder centered on the pipe axis X14.

The body 12 is thus a female part and the pipe 14 a male part, which are assembled by fitting the pipe into the body.

The housing 10 includes a sealing gasket 30, which is mounted on the cylindrical outer face 28 of the pipe 14. In the example, the pipe 14 has a rib 32 and a shoulder 34, which between them form a groove wherein the sealing gasket 30 is held.

When the housing 10 is assembled, the sealing gasket 30 is compressed between the cylindrical outer face 28 of the pipe 14 and the cylindrical wall 18 of the body 12. Thus, the assembly between the body 12 and the pipe 14 is sealed, so that a flow of fluid between the cylindrical wall 18 of the body and the cylindrical outer face 28 of the pipe is prevented.

With the body and pipe axes X12 and X14 being coincident in the assembled configuration of the housing, it is understood that the mounting of the cylindrical outer face 28 of the pipe 14 in the cylindrical wall 18 of the body 12 prevents a translation of the pipe perpendicularly to the pipe axis and a rotation of the pipe around an axis not coincident with the pipe axis, but does not prevent a translation of the pipe along the pipe axis or a rotation of the pipe around the pipe axis.

Advantageously, the housing 10 comprises a regulating element 36, which is a thermostatic regulating element in the example, also called a thermostatic device, such as a wax expansion device. The regulating element 36 is fixed to one end of the pipe 14, at the first end 24 of the duct 22, to extend into the chamber 16 in the assembled configuration of the housing. More precisely, the regulating element 36 is fixed here to one end of the cylindrical outer face 28 of the pipe 14. The regulating element 36 is configured to regulate a flow of fluid in the chamber 16, and, more precisely, a flow of fluid between the duct 22 and the chamber, by more or less obstructing the duct 22 depending on the temperature of the of fluid flowing along the regulating element 36, for example. To this end, the regulating element 36 includes a valve 38, movable along the pipe axis X14. The operation and design of the regulating element 36, known per se, are not detailed here. In a non-represented variant of the invention, the regulating element 36 is a thermostatic device of another type, such as a controlled regulating element, with a heating cartridge, for example, or even is not a thermostatic device, such as a motorized actuator, for example.

The body 12 defines a body plane P12, which separates the body into a lower part 12A. and an upper part 12B. The body plane P12 is parallel to the body axis X12, and, in the example, the body axis X12 is comprised in the body plane P12.

The pipe 14 defines a pipe plane P14, which separates the pipe into a lower part 14A and an upper part 14B. The pipe plane P14 is parallel to the pipe axis X14, and, in the example, the pipe axis X14 is comprised in the pipe plane P14.

In the assembled configuration of the housing 10, the body and pipe planes P12 and P14 are coincident, and separate the housing into a lower part 10A, which corresponds to the lower part 12A of the body 12 and the lower part 14A of the pipe, and an upper part 10B, which corresponds to the upper part 12B of the body and the upper part 14B of the pipe.

To enable the assembly of the housing 10, the body 12 comprises a first lug 40, traversed by a cylindrical opening 42 extending along an axis X42, and a second lug 44, traversed by a cylindrical opening 46 extending along an axis X46. In addition, the pipe 14 comprises a first lug 48, traversed by a cylindrical opening 50 extending along an axis X50, and a second lug 52, traversed by a cylindrical opening 54 extending along an axis X54.

In the example, the first lugs 40 and 48 of the body and the pipe are shown on the left of the housing 10, and the second lugs 44 and 52 of the body and the pipe are shown on the right of the housing 10, according to the viewing angle of FIG. 4. In a variant, the first lugs of the body and the pipe correspond to the lugs on the right of the housing, and the second lugs of the body and the pipe correspond to the lugs on the left of the housing, according to the viewing angle of FIG. 4.

It is understood that the lugs 40, 44, 48, and 50 are located outside the chamber 16 and the duct 22, that is, on the outside of the housing 10.

In the example, the axes X42 and X46 are both orthoradial to the body axis X12, and the axes X50 and X54 are both orthoradial to the pipe axis X14.

In addition, in the example, the cylindrical openings 42, 46, 50, and 54 are right circular cylinders.

Preferably, the first and second lugs 40, 44 of the body 12 are aligned along an axis perpendicular to the body axis X12, and the first and second lugs 48, 52 of the pipe 14 are aligned along an axis perpendicular to the pipe axis X14.

The housing 10 also comprises a first pin 56, which extends along an axis X56, and a second pin 58, which extends along an axis X58.

The pins 56 and 58 are hollow cylindrical pins. In the example, the pins 56 and 58 are also split elastic pins.

In the assembled configuration of the housing 10, the axes X42, X50, and X56 are coincident, so that the cylindrical openings 42 and 50 of the first lugs 40 and 48 and the first pin 56 are aligned, and the cylindrical openings 42 and 50 are traversed by the first pin 56. Similarly, the axes X46, X54, and X58 are coincident, so that the cylindrical openings 46 and 54 of the second lugs 44 and 52 and the second pin 58 are aligned, and the cylindrical openings 46 and 54 are traversed by the second pin 58.

It is then understood that the diameter of the cylindrical openings 42 and 50, on the one hand, and 46 and 54, on the other hand, is substantially equal to the diameter of the pin 56, on the one hand, and the pin 58, on the other hand.

Thus, in the assembled configuration of the housing 10, the pins 56 and 58 prevent the translation of the pipe 14 relative to the body 12 along the pipe axis X14 as well as the rotation of the pipe relative to the body around the pipe axis. Thanks to the movements prevented by the pins 56 and 58 and thanks to the movements prevented by the interaction between the cylindrical outer face 28 of the pipe 14 with the cylindrical wall 18 of the body 12, any relative movement between the pipe and the body is prevented when the housing is in the assembled configuration.

Thanks to their interaction with the openings 42, 46, 50 and 54 of the lugs 40, 44, 48 and 52, the pins 56 and 58 thus enable assembling the housing 10.

Advantageously, it is noted that of the first lug 40 of the body 12 and the first lug 48 of the pipe 14, one is located in the lower part 10A of the housing 10 and the other is located in the upper part 10B of the housing. Similarly, of the second lug 44 of the body and the second lug 52 of the pipe, one is located in the lower part of the housing and the other is located in the upper part of the housing. Thus, and as is better visible in FIG. 3, the planes P12 and P14 pass between the lugs of the body and the pipe.

More particularly advantageously, the first lug 40 of the body 12 is located in the upper part 10B of the housing 10, and the second lug 44 of the body is located in the lower part 10A of the housing. In addition, the first lug 48 of the pipe 14 is located in the lower part 10A of the housing 10 and the second lug 52 of the pipe is located in the upper part 10B of the housing. This arrangement of the lugs facilitates the assembly of the housing, as explained below.

In addition to the assembly of the body 12 and the pipe 14 to form the housing 10, the pins 56 and 58 and the lugs 40, 44, 48, and 52 also enable fixing the housing 10 to a support 60, represented in a simplified manner in FIGS. 1 to 3 only. The support 60 is a casing belonging to a vehicle wherein the housing 10 is mounted, for example.

In the example, the support 60 has a first fixing tab 62, a second fixing tab 64, and, optionally, a third fixing tab 66.

The housing 10 is pressed against the support 60, with the first lug 48 of the pipe 14 in contact against the first fixing tab 62 and with the second lug 44 of the body 12 in contact with the second fixing tab 64. Optionally, the body 12 also has a fixing zone 68, which is in contact against the third fixing tab 66. Preferably, this fixing zone 68 includes an opening wherein a third hollow cylindrical pin 70 is mounted, which is advantageously a split elastic pin.

The housing 10 is fixed to the support 60 thanks to a first fastening member 72, thanks to a second fastening member 74, and, optionally, thanks to a third fastening member 76.

The first fastening member 72 passes through the first pin 56, and thus also passes through the openings 42 and 50 of the lugs 40 and 48. In addition, the first fastening member 72 is fixed in the first fixing tab 62 of the support 60, to maintain the lugs 40 and 48 pressed against the support 60. In the example, the first fastening member 72 is a screw, whose head is pressed against the first lug 40 of the body 12 and against the first pin 56, and whose threaded rod is screwed into the first fixing tab 62.

The second fastening member 74 passes through the second pin 58, and thus also passes through the openings 46 and 54 of the lugs 44 and 52. In addition, the second fastening member 74 is fixed in the second fixing tab 64 of the support 60, to maintain the lugs 44 and 52 pressed against the support 60. In the example, the second fastening member 74 is a screw, whose head is pressed against the second lug 52 of the pipe 14 and against the second pin 58, and whose threaded rod is screwed into the second fixing tab 64.

Optionally, the third fastening member 76 passes through the third pin 70, and thus also passes through the fixing zone 68 of the body 12. In addition, the third fastening member 76 is fixed in the third fixing tab 66 of the support 60, to maintain the fixing zone 68 pressed against the support 60. In the example, the third fastening member 76 is a screw, whose head is pressed against the fixing zone 68 of the body 12 and whose threaded rod is screwed into the third fixing tab 66.

Thus, thanks to the fastening members 72 and 74, and optionally thanks to the fastening member 76, the housing 10 is fixed to the support 60.

The fact that the pins 56 and 58 and the lugs 40, 44, 48 and 52 enable both assembling the housing 10 and fixing the housing 10 to the support 60 is particularly advantageous, as it enables facilitating the assembly and mounting of the housing while optimizing its bulk, thus reducing its manufacturing cost.

Preferably, the pins 56, 58, and 70 are made of metal, such as steel, while the body 12 and the pipe 14 are made of plastic material, particularly thermoplastic, such as for example polyamide 6-6, polyphthalamide, polyphenylene sulfide, or polyarylamide.

The fact that the fixing of the housing 10 is carried out by passing the fastening members 72,74, and 76 through the pins 56, 58, and 70 is particularly advantageous for protecting the housing 10 from possible damage and deformation. Indeed, with the body 12 and the pipe 14 being made of plastic material, they are more deformable than the pins, made of metal. In case of excessive tightening of the fastening members 72, 74, and 76, the head of the fastening members compresses the pins against the support 60, which avoids compressing the body 12 and the pipe 14. In other words, the deformations of the body 12 and the pipe 14 are controlled and limited by the lesser deformations of the pins, which thus act as spacers. The use of pins to fix the housing 10 to the support 60 thus enables applying significant tightening forces with the fastening members without risking damaging the body 12 and the pipe 14. In addition, the pins 56, 58, and 70 enable absorbing possible shear forces between the housing 10 and the support 60 without risking damaging the housing 10 or the fastening members 72, 74, and 76, with the pins being particularly suitable for absorbing such shear forces.

In practice, the housing 10 is dimensioned so that the cumulative height of the first lugs of the body and the pipe is substantially equal to the height of the pins 56 and 58.

A method for assembling the housing 10 is now described, with reference to FIGS. 5 to 8.

This assembly method begins with the positioning of the pipe 14 in front of the body 12, so that the pipe axis X14 is coincident with the body axis X12 and so that the first end 24 of the duct 22 is oriented in front of the chamber 16. In addition, the pipe is positioned so that the cylindrical opening 50 of the first lug 48 of the pipe and the cylindrical opening 42 of the first lug 40 of the body extend along non-parallel axes, and so that the cylindrical opening 54 of the second lug 52 of the pipe and the cylindrical opening 46 of the second lug 44 of the body extend along non-parallel axes. In other words, the pipe is positioned so that the pipe plane P14 is angularly offset from the body plane P12. This offset angle is between 10° and 90°, for example.

At the end of this positioning, the housing 10 is in the configuration shown in FIG. 5.

Then, the pipe 14 is brought towards the body 12 in a translational movement of the pipe along the pipe axis X14 to insert the first end 24 of the duct 22 into the chamber 16, until the cylindrical opening 50 of the first lug 48 of the pipe and the cylindrical opening 42 of the first lug 40 of the body extend along intersecting axes, and so that the cylindrical opening 54 of the second lug 52 of the pipe and the cylindrical opening 46 of the second lug 44 of the body extend along intersecting axes. In other words, the pipe is brought to the body until aligning the lugs of the pipe and the body along the pipe axis X14.

During this translational movement, the first end 24 is thus inserted into the chamber 16, and the sealing gasket 30 is thus compressed between the cylindrical outer face 28 of the pipe 14 and the cylindrical wall 18 of the body 12. At the end of this translation, the housing 10 is in the configuration shown in FIG. 6.

Then, the pipe 14 is rotated around the pipe axis X14, until the cylindrical opening 50 of the first lug 48 of the pipe is aligned with the cylindrical opening 42 of the first lug 40 of the body 12, and until the cylindrical opening 54 of the second lug 52 of the pipe is aligned with the cylindrical opening 46 of the second lug 44 of the body. In other words, the pipe 14 is rotated around the pipe axis until bringing the lugs of the pipe into contact with the lugs of the body. At the end of this rotational movement, the pipe plane P14 is coincident with the body plane P12, and the housing 10 is in the configuration shown in FIG. 7.

Together, the translational movement and then the rotational movement of the pipe lead to the pipe 14 being brought towards the body 12 to insert the first end 24 of the duct 22 into the chamber 16, until the cylindrical openings of the lugs of the pipe are aligned with the cylindrical openings of the lugs of the body.

Then, the first pin 56 is inserted into the cylindrical openings 52 and 50 of the first lugs 40 and 48 of the body 12 and the pipe 14, and the second pin 58 is inserted into the cylindrical openings 46 and 54 of the second lugs 44 and 52 of the body and the pipe, enabling assembling the pipe and the body together. For this, the pin 56 is positioned so that the axis X56 is coincident with the axes X42 and X50, and the pin 58 is positioned so that the axis X58 is coincident with the axes X46 and X54. Then, the pins 56 and 58 are inserted into the cylindrical openings by a translational movement of the pins along the axes of the cylindrical openings and the pins. At the end of this insertion of the pins, the housing 10 is assembled and is in the configuration shown in FIG. 8.

This assembly method makes the assembly of the housing 10 particularly simple to carry out, so that the assembly can easily be automated by a machine tool, such as a robot.

In particular, thanks to the relative positioning of the lugs 40 and 44 of the body 12 and the lugs 48 and 52 of the pipe 14, the approach of the pipe towards the body is advantageously carried out in two successive steps, namely a translation and then a rotation, which facilitates the positioning of the pipe on the body. Indeed, thanks to this two-step approach, the initial positioning of the pipe relative to the body does not need to be precise. More precisely, due to the offset angle between the pipe plane P14 and the body plane P12, a collision between the lugs of the pipe and the lugs of the body is not possible during the translation of the pipe towards the body. The relative positioning of the lugs of the body and the pipe thus facilitates the automation of the assembly of the housing 10 by a machine tool.

The fact that the pins 56 and 58 are split elastic pins facilitates their insertion into the cylindrical openings of the lugs, because the pins can be tightened at the time of their insertion, to have a smaller outer diameter than the diameter of the non-tightened pins, and thus a smaller outer diameter than the diameter of the cylindrical openings.

In addition, with the pins 56 and 58 being split elastic pins, they have a slight play, which enables a slight relative movement of the pipe 14 relative to the body 12, along the pipe axis X14. This movement has no influence on the operation of the housing 10 and its thermostatic device 36, particularly since the pipe 14 can accept a displacement relative to the body 12 along the pipe axis X14 without breaking the seal of the housing 10: since the cylindrical outer face 28 and the cylindrical wall 18 are two coaxial cylindrical structures, a sliding of one relative to the other does not reduce the seal provided by the sealing gasket 30.

A second embodiment of a housing 100 according to the invention is shown in FIG. 9. In the second embodiment, the elements analogous to those of the first embodiment bear the same references and operate in the same way. In the following, mainly the differences between the first and second embodiments are described.

In addition, if a component is mentioned in the description of the second embodiment without being shown in FIG. 9, it corresponds to the same element shown in FIGS. 1 to 8 for the first embodiment.

The housing 100 of the second embodiment differs from the housing 10 of the first embodiment by the position of the first lugs of the body 12 and the pipe 14.

Indeed, in the housing 100, the first lug 40 of the body 12 is located in the lower part 10A of the housing 10, and the first lug 48 of the pipe 14 is located in the upper part 10B of the housing. Thus, in the second embodiment, the two lugs of the body 12 are located in the same part of the body, namely the lower part 12A of the body, and the two lugs of the pipe 14 are located in the same part of the pipe, namely the upper part 14B of the pipe. In a non-represented variant of the second embodiment, the two lugs of the body 12 are located in the upper part 12B of the body, and the two lugs of the pipe 14 are located in the lower part 14A of the pipe.

The assembly method of the housing 100 of the second embodiment differs from the assembly method of the housing 10 of the first embodiment.

This assembly method begins with the positioning of the pipe 14 in front of the body 12, so that the pipe axis X14 is coincident with the body axis X12 and so that the first end 24 of the duct 22 is oriented in front of the chamber 16. In addition, the pipe is positioned so that the cylindrical opening 50 of the first lug 48 of the pipe and the cylindrical opening 42 of the first lug 40 of the body extend along parallel axes, and so that the cylindrical opening 54 of the second lug 52 of the pipe and the cylindrical opening 46 of the second lug 44 of the body extend along parallel axes. In other words, the pipe is positioned so that the pipe plane P14 is coincident with the body plane P12.

Then, the pipe 14 is brought towards the body 12 in a translational movement of the pipe along the pipe axis X14 to insert the first end 24 of the duct 22 into the chamber 16, until the cylindrical opening 50 of the first lug 48 of the pipe and the cylindrical opening 42 of the first lug 40 of the body extend along coincident axes, and so that the cylindrical opening 54 of the second lug 52 of the pipe and the cylindrical opening 46 of the second lug 44 of the body extend along coincident axes. In other words, the pipe is brought to the body until aligning the lugs of the pipe and the body along the pipe axis X14 and until the cylindrical openings 52 and 54 of the first lug 48 and the second lug 52 of the pipe 14 are aligned with the cylindrical openings 42 and 46 of the first lug 40 and the second lug 44 of the body 12, respectively. Thus, the approach of the pipe towards the body is carried out in a pure translational movement, without rotation.

Then, the first pin 56 is inserted into the cylindrical openings 52 and 50 of the first lugs 40 and 48 of the body 12 and the pipe 14, and the second pin 58 is inserted into the cylindrical openings 46 and 54 of the second lugs 44 and 52 of the body and the pipe, enabling assembling the pipe and the body together. For this, the pin 56 is positioned so that the axis X56 is coincident with the axes X42 and X50, and the pin 58 is positioned so that the axis X58 is coincident with the axes X46 and X54. Then, the pins 56 and 58 are inserted into the cylindrical openings by a translational movement of the pins along the axes of the cylindrical openings and the pins.

At the end of this insertion of the pins, the housing 100 is assembled and is in the configuration shown in FIG. 9.

Advantageously, the assembly method of the housing 100 is faster to implement than the assembly method of the housing 10, insofar as the approach of the pipe 14 towards the body 12 is carried out in a single translation step, without requiring rotation. The assembly of the housing 100 is thus faster to carry out.

In a non-represented variant of the invention, the housings 10 and 100 have a different number of channels, such as two, three, or four channels, in all cases with at least one channel formed at the pipe 14 and at least one channel formed at the body 12.

In a non-represented variant of the invention, the body 12 and the pipe 14 each have only one lug, instead of two lugs. The assembly of the pipe and the body is then carried out with only one pin, which further increases the compactness of the housing 10 or 100, and facilitates its assembly.

In a non-represented variant of the invention, the cylindrical openings 42, 46, 50 and 54 of the lugs 40, 44, 48 and 52 are not straight circular cylinders, but other cylinders, such as cylinders with an oval or polygonal section, which may be straight or non-straight.

In a non-represented variant of the invention, the fastening members 72, 74, and 76 are not screws, but bolts comprising a nut and a screw passing through the corresponding fixing tab 62, 64 or 66.

In a non-represented variant of the invention, the axes X42, X50 and X56, on the one hand, and the axes X46, X54 and X58, on the other hand, are not orthoradial to the body and pipe axes X12 and X14, but are inclined with respect to orthoradial axes to the body and pipe axes X12 and X14, without being parallel to the body and pipe axes. In other words, the openings 42, 46, 50 and 54 are oriented inclined with respect to the body and pipe axes X12 and X14. In other words, in such a variant, the X42, X50, X56, X46, X54 and X58 intersect with the body and pipe planes P12 and P14.

In a non-represented variant of the invention, the body plane P12 that separates the body into a lower part 12A. and an upper part 12B is parallel to the body axis X12 but the body axis is not comprised in the body plane. In other words, the body plane P12 does not separate the body into two equal parts. Similarly, the pipe plane P14 is parallel to the pipe axis X14 without comprising the pipe axis, and so as to be coincident with the body plane in the assembled configuration of the housing 10 or 100. In such a variant, the lugs of the body and the pipe are offset compared to the first and second embodiments described above, so that among the first lug of the body and the first lug of the pipe, one is located in the lower part of the housing and the other is located in the upper part of the housing, and among the second lug of the body and the second lug of the pipe, one is located in the lower part of the housing and the other is located in the upper part of the housing.

In a non-represented variant of the invention, the lower part 12A of the body 12 is separated from the upper part 12B of the body not by a plane parallel to the body axis X12, but by two half-planes, each of the two half-planes being delimited by the body axis, the two half-planes being inclined with respect to each other. In other words, viewed perpendicularly to the body axis X12, the lower part 12A corresponds to a first angular sector of the body whose vertex is carried by the body axis, and the upper part 12B corresponds to a second angular sector of the body whose vertex is carried by the body axis, which is complementary to the first angular sector. Similarly, the lower part 14A of the pipe 14 is separated from the upper part 14B of the pipe by two half-planes, which are coincident with those of the body in the assembled configuration of the housing 10 or 100. In such a variant, it is then understood that the axes X42, X50 and X56, on the one hand, and the axes X46, X54 and X58, on the other hand, are not parallel to each other, but intersect with each other, in the assembled configuration of the housing. In other words, the first lugs of the body and the pipe are angularly offset with respect to the second lugs of the body and the pipe.

Any feature described for one embodiment or variant in the above can be implemented for the other embodiments and variants described above, as long as technically feasible.

1. A fluid-circulation housing with multiple channels, including a body and a pipe assembled to each other, wherein:
the body comprises a chamber centered on a body axis, and at least one opening leading into the chamber and forming one of the channels of the housing; and
the pipe includes a duct centered on a pipe axis and having a first end and a second end,
wherein, in an assembled configuration of the housing
the pipe axis and the body axis are coincident;
the first end of the duct opens into the chamber;
the second end of the duct forms one of the channels of the housing wherein:
the body, outside the chamber, comprises a first lug traversed by a cylindrical opening oriented inclined with respect to the body axis;
the pipe, outside the duct, comprises a first lug traversed by a cylindrical opening oriented inclined with respect to the pipe axis;
the housing further includes a first hollow cylindrical pin; and
in the assembled configuration of the housing the cylindrical opening of the first lug of the body and the cylindrical opening of the first lug of the pipe are aligned and are traversed by the first pin to assemble the body and the pipe to each other, and the first pin is configured to receive a first fastening member to fix the housing to a support.

2. The housing according to claim 1, wherein the cylindrical opening of the first lug of the body is oriented along an axis orthoradial to the body axis, and wherein the cylindrical opening of the first lug of the pipe is oriented along an axis orthoradial to the pipe axis.

3. The housing according to one of claim 1, wherein:
the body, outside the chamber, further comprises a second lug traversed by a cylindrical opening oriented inclined with respect to the body axis, or oriented along an orthoradial axis to the body axis;
the pipe, outside the duct, further comprises a second lug traversed by a cylindrical opening oriented inclined with respect to the pipe axis, or oriented along an orthoradial axis to the pipe axis;
the housing further includes a second pin, which is a hollow cylindrical pin, configured to receive a second fastening member to fix the housing to the support;
in the assembled configuration of the housing the cylindrical opening of the second lug of the body and the cylindrical opening of the second lug of the pipe are aligned and are traversed by the second pin to assemble the body and the pipe to each other.

4. The housing according to claim 3, wherein:
the body defines a body plane, parallel to the body axis and separating the body between a lower part and an upper part; and
the pipe defines a pipe plane, parallel to the pipe axis and separating the pipe between a lower part and an upper part, and wherein, in the assembled configuration of the housing
the body plane is coincident with the pipe plane, the housing being separated by the body and pipe planes between a lower part, corresponding to the lower part of the body and the lower part of the pipe, and an upper part, corresponding to the upper part of the body and the upper part of the pipe;
among the first lug of the body and the first lug of the pipe, one is located in the lower part of the housing and the other is located in the upper part of the housing; and
among the second lug of the body and the second lug of the pipe, one is located in the lower part of the housing and the other is located in the upper part of the housing.

5. The housing according to claim 4, wherein, in the assembled configuration of the housing:
among the first lug of the body and the second lug of the body, one is located in the lower part of the housing and the other is located in the upper part of the housing; and
among the first lug of the pipe and the second lug of the pipe, one is located in the lower part of the housing and the other is located in the upper part of the housing.

6. The housing according to claim 4, wherein, in the assembled configuration of the housing:
the first lug of the body and the second lug of the body are located in one of the lower part and upper part of the housing; and
the first lug of the pipe and the second lug of the pipe are located in the other of the lower part and upper part of the housing.

7. The housing according to claim 1, wherein:
the chamber is delimited at least in part by a cylindrical wall centered on the body axis;
the pipe comprises a cylindrical outer face extending, at the first end of the duct, along the pipe axis being centered on the pipe axis;
the housing further includes a sealing gasket, mounted on the cylindrical outer face of the pipe; and
in the assembled configuration of the housing the sealing gasket is compressed between the cylindrical outer face of the pipe and the cylindrical wall of the body.

8. The housing according to one of claim 1, further comprising a regulating element fixed at the first end of the duct to extend into the chamber in the assembled configuration of the housing, the regulating element being configured to regulate a flow of fluid in the chamber, the regulating element preferably being a thermostatic regulating element.

9. An assembly comprising the housing according to claim 1, as well as the support and the first fastening member, wherein the housing is in an assembled configuration and the first fastening member passes through the first pin being fixed to the support, to maintain the first lug of the body and the first lug of the pipe pressed against the support to fix the housing to the support.

10. A method for assembling a fluid-circulation housing with multiple channels according to claim 1, comprising, in this order:
positioning the pipe in front of the body so that the pipe axis is coincident with the body axis and so that the first end of the duct is oriented in front of the chamber;
bringing the pipe towards the body to insert the first end of the duct into the chamber, until the cylindrical opening of the first lug of the pipe is aligned with the cylindrical opening of the first lug of the body; and
inserting the first pin into the cylindrical opening of the first lug of the body and into the cylindrical opening of the first lug of the pipe.

11. The method for assembling according to claim 10, wherein:
the positioning of the pipe in front of the body is carried out so that the cylindrical opening of the first lug of the pipe and the cylindrical opening of the first lug of the body extend along parallel axes, and
the approach of the pipe towards the body is carried out by a translational movement along the pipe axis, without rotation around the pipe axis.

12. The method for assembling according to claim 10, wherein:
the positioning of the pipe in front of the body is carried out so that the cylindrical opening of the first lug of the pipe and the cylindrical opening of the first lug of the body extend along non-parallel axes, and
the approach of the pipe towards the body is carried out by two successive movements:
a translational movement of the pipe along the pipe axis to insert the first end of the duct into the chamber, until the cylindrical opening of the first lug of the pipe and the cylindrical opening of the first lug of the body extend along intersecting axes then
a rotational movement of the pipe around the pipe axis, until the cylindrical opening of the first lug of the pipe is aligned with the cylindrical opening of the first lug of the body.
